(19) United States
(12) Patent Application Publication
(10) Pub. No.: US 2022/0182400 A1
(43) Pub. Date: Jun. 9, 2022

(54) CONTEXT-AWARE SECURITY FRAMEWORK FOR A SMART ENVIRONMENT

(71) Applicants: Amit Kumar Sikder, Miami, FL (US); Hidayet Aksu, Miami, FL (US); A. Selcuk Uluagac, Miami, FL (US)

(72) Inventors: Amit Kumar Sikder, Miami, FL (US); Hidayet Aksu, Miami, FL (US); A. Selcuk Uluagac, Miami, FL (US)

(73) Assignee: The Florida International University Board of Trustees, Miami, FL (US)

(21) Appl. No.: 17/112,204

(22) Filed: Dec. 4, 2020

(51) Int. Cl. H04L 29/06; G06N 20/00

(52) U.S. Cl. CPC H04L 63/1425; G06N 20/00

(57) ABSTRACT

Context-aware security frameworks to detect malicious behavior in a smart environment (e.g., a home, office, or other building) are provided. The framework can address the emerging threats to smart environments by observing the changing patterns of the conditions (e.g., active/inactive) of smart entities (e.g., sensors and other devices) of the smart environment for different user activities, and building a contextual model to detect malicious activities in the smart environment.

### GOVERNMENT SUPPORT

This invention was made with government support under NSF-CNS-1453647 awarded by National Science Foundation. The government has certain rights in the invention.

### BACKGROUND

The concept of smart environments (e.g., home, office, building) has already started to redesign day-to-day living. The functions of smart devices have grown from simply controlling lights and opening garage doors to connecting physical and living spaces to the cyber world. Nowadays, a smart environment integrates diverse sets of devices from home security, voice-activated speakers, hubs, and/or smart cooking ranges to smart meters to provide more autonomous, efficient, and convenient daily operations than ever before. For instance, smart switches and sensor-activated smart lights offer energy efficiency. Smart locks, motion activated cameras, and intelligent fire alarms offer a secure home environment. Voice-activated smart speakers can play mood-specific music, provide information from the web, or even shop online for users to provide a comfortable and autonomous home setting. Compared to early smart systems with fixed device setups, limited functionalities, and minimum user control over the systems, modern smart environments provide a more user-centric, application (app)-based platform where users can set and configure their smart home devices easily. Similar to smartphones, users can also download different apps from an app market, which makes smart environments more popular and versatile than ever.

The inclusion of app development platforms increases the functionalities of smart systems, but it also exposes the vulnerabilities of smart devices to potential attackers, who can exploit smart environment devices in several ways. Attackers can perform denial-of-service (DoS) attacks to obstruct normal operations of devices, compromise one device and get access to other connected devices, or even obtain and/or leak personal information (e.g., an unlock code of a smart lock that can be used to gain physical access to the home, office, or building). Nonetheless, a comprehensive security solution that can detect these emerging threats associated with smart environment devices does not exist and is direly needed.

### BRIEF SUMMARY

Embodiments of the subject invention provide novel and advantageous context-aware security frameworks to detect malicious behavior in a smart environment (e.g., a home, office, or other building). Systems and methods of embodiments of the subject invention can include the framework and can address the emerging threats to, and the current shortcomings of, smart environments. The framework/system/method can observe the changing patterns of the conditions (e.g., active/active) of smart entities (e.g., sensors and other devices) of the smart environment for different user activities, and build a contextual model to detect malicious activities in the smart environment.

In an embodiment, a system for monitoring activity within a smart environment can comprise: a processor; and a machine-readable medium in operable communication with the processor and devices and sensors of the smart environment, the machine-readable medium having instructions stored thereon that, when executed by the processor, perform the following steps: collecting, from the devices and the sensors of the smart environment, data comprising states of the devices and the sensors; building context arrays of activities of users of the smart environment based on the data collected from the devices and the sensors, the context arrays comprising a device context array for the devices and a sensor context array for the sensors; training a machine learning model, using the context arrays to establish benign behavior, to provide a trained machine learning model; and monitoring the smart environment, using the trained machine learning model, to detect malicious activity within the smart environment. The collecting of the data can further comprise collecting data from at least one controller of the smart environment, and the context arrays can further comprise a controller context array. The machine learning model can be, for example, a Markov Chain model. The monitoring of the smart environment can comprise comparing detected behavior to the established benign behavior and designating the detected behavior as malicious if it is distinct from the established benign behavior. The collecting of the data can occur over a predetermined period of time during which the smart environment is being used by the users. The smart environment can be a smart home, smart office, or smart building. The data can comprise device features extracted from the devices, sensor features extracted from the sensors, and controller features extracted from at least one controller of the smart environment, and the building of the context arrays can comprise using the device features to build the device context array, using the sensor features to build the sensor context array, and using the controller features to build the controller context array. The device features can comprise logical states of the devices, the sensor features can comprise logical states and numerical values of the sensors, and the controller features can comprise control commands of the at least one controller. The controller features can further comprise a location of the at least one controller. The at least one controller can comprise, for example, a smartphone, a tablet, or both.

In another embodiment, a method for monitoring activity within a smart environment can comprise: collecting, by a processor in operable communication with devices and sensors of the smart environment, data from the devices and the sensors of the smart environment, the data comprising states of the devices and the sensors; building, by the processor, context arrays of activities of users of the smart environment based on the data collected from the devices and the sensors, the context arrays comprising a device context array for the devices and a sensor context array for the sensors; training, by the processor, a machine learning model, using the context arrays to establish benign behavior, to provide a trained machine learning model; and monitoring, by the processor, the smart environment using the trained machine learning model to detect malicious activity within the smart environment. The collecting of the data can further comprise collecting data from at least one controller of the smart environment, and the context arrays can further comprise a controller context array. The machine learning model can be, for example, a Markov Chain model. The monitoring of the smart environment can comprise comparing detected behavior to the established benign behavior and designating the detected behavior as malicious if it is distinct from the established benign behavior. The collecting of the data can occur over a predetermined period of time during which the smart environment is being used by the users. The smart environment can be a smart home, smart office, or smart building. The data can comprise device features extracted from the devices, sensor features extracted from the sensors, and controller features extracted from at least one controller of the smart environment, and the building of the context arrays can comprise using the device features to build the device context array, using the sensor features to build the sensor context array, and using the controller features to build the controller context array. The device features can comprise logical states of the devices, the sensor features can comprise logical states and numerical values of the sensors, and the controller features can comprise control commands of the at least one controller. The controller features can further comprise a location of the at least one controller. The at least one controller can comprise, for example, a smartphone, a tablet, or both.

### BRIEF DESCRIPTION OF DRAWINGS

FIG. 1 is a schematic view showing a smart home system and its major components

FIG. 2 is a schematic view showing context-aware modeling of a security framework, according to an embodiment of the subject invention.

FIG. 3 is a schematic view of a security framework, according to an embodiment of the subject invention.

FIG. 4 is a schematic view of a Markov chain model for a security framework, according to an embodiment of the subject invention.

FIGS. 5(a)-5(d) are charts showing performance metrics of a security framework of an embodiment of the subject invention, with different conditions. In each chart, the true positive (TP) rate, false negative (FN) rate, accuracy rate, and F-score are shown in the four groupings, respectively (from left to right). Within each grouping, the bar on the left is for single bedroom, the bar in the middle is for double bedroom, and the bar on the right is for duplex home. FIG. 5(a) shows performance metrics for the case without a motion sensor;

FIG. 5(b) shows performance metrics for the case without a door sensor; FIG. 5(c) shows performance metrics for the case without a temperature sensor; and FIG. 5(d) shows performance metrics for the case without a light sensor.

FIGS. 6(a)-6(c) are plots showing accuracy rate versus the number of sensors for a security framework of an embodiment of the subject invention, with different conditions.

FIG. 6(a) shows a plot for a single bedroom layout; FIG. 6(b) shows a plot for a double bedroom layout; and FIG. 6(c) shows a plot for a duplex home layout.

FIGS. 7(a)-7(b) are charts showing performance metrics of a security framework of an embodiment of the subject invention in a policy-enforced smart home system (SHS), with different conditions. In each chart, the TP rate, FN rate, accuracy rate, and F-score are shown in the four groupings, respectively (from left to right). Within each grouping, the bar on the left is for single bedroom, the bar in the middle is for double bedroom, and the bar on the right is for duplex home. FIG. 7(a) shows performance metrics for User Policy 1; and FIG. 7(b) shows performance metrics for User Policy 2.

FIG. 8(a) is a plot showing accuracy rate versus the number of benign applications (apps) for a security framework of an embodiment of the subject invention. The curve with the lowest accuracy rate is for Threat 3; the curve with the second-lowest accuracy rate is for Threat 4; the curve with the third-lowest accuracy rate is for Threat 5; the curve with the fourth-lowest accuracy rate is for Threat 1; and the curve with the highest accuracy rate is for Threat 2.

FIG. 8(b) is a plot showing accuracy rate versus the number of malicious apps for a security framework of an embodiment of the subject invention.

FIG. 9 is a schematic view of a single bedroom smart home layout used in an emulator.

### DETAILED DESCRIPTION

Embodiments of the subject invention provide novel and advantageous context-aware security frameworks to detect malicious behavior in a smart environment (e.g., a home, office, or other building). Systems and methods of embodiments of the subject invention can include the framework and can address the emerging threats to, and the current shortcomings of, smart environments. The framework/system/method can observe the changing patterns of the conditions (e.g., active/active) of smart entities (e.g., sensors and other devices) of the smart environment for different user activities, and build a contextual model to detect malicious activities in the smart environment.

As used herein, context-awareness refers to the ability to understand the changes in sensors and devices due to on-going user activities and determine if the behavior of a smart system is benign or not. Smart environment devices are configured with different sensors to provide autonomous control and uninterrupted operation; thus, different sensors in a smart environment can sense user activities (e.g., motion, opening doors, etc.) and trigger associated devices to perform pre-defined tasks. Systems and methods can correlate these sensor-device relations with different user activities and build a context-aware model to define benign user behavior. The security framework can observe current states (active or inactive) of smart environment sensors and devices and compare with learned user behavior to detect malicious behavior in a smart environment. For example, machine learning detection techniques (e.g., a Markov Chain-based machine learning detection technique) can be used to detect malicious behavior, and malicious app behavior in a smart environment can be detected with high accuracy. Embodiments require low system overhead in real smart devices while providing simple context-aware approaches based on machine learning techniques for malicious behavior detection in smart environments.

Related art systems and methods do not capture or account for the context of user activities and/or sensor-device-user interactions (e.g., movement directions, sensors activated, rooms involved). For example, if a user walks from a bedroom (or office room) to a hallway, the user may have to activate multiple devices and sensors along his or her path (i.e., walking context) in a certain sequence (e.g., moving towards the bedroom door, opening the door, entering the hallway, closing the door, and reaching to the hallway). A user cannot simply skip all (or in some cases, any) of these steps and reach the hallway directly from the bedroom. In related art systems and methods, a contextual awareness into the devices and applications due to these types of sensor-device-user interactions is not accounted for or captured.

Smart environment systems have become very popular recently with the user-centric customization options and third-party app development platforms. Researchers and developers have offered different apps to increase the functionalities of smart environment devices. The introduction of app-based smart home platforms increases the functionalities as well as introduces several malicious threats to smart environments. Some platforms, such as Samsung SmartThings, perform manual checking before publishing an app in the app market. However, users can install an app using the cloud platform by simply copying the source code of an app and publishing the app onto their own smart environments. Unlike smartphone apps, smart home apps only ask for user permissions at installation time and do not need any permission at run-time, which allows attackers to invade smart environment systems easily. Related art systems use either an enhanced permission model for smart home systems (SHSs), which depends on explicit user permission, or analyzing source code for detecting vulnerabilities in the code logic, which is only effective against specific type of attacks (see, e.g.; Chakravorty et al., “Privacy preserving data analytics for smart homes”, Security and Privacy Workshops (SPW), 2013 IEEE; Mohsin et al., “IoTSAT: A formal framework for security analysis of the internet of things (IoT)”, Communications and Network Security (CNS), 2016 IEEE Conference; Jia et al., “ContexIoT: Towards providing contextual integrity to appified IoT platforms”, Proceedings of the Network and Distributed System Security Symposium, 2017; and Celik et al., “Sensitive Information Tracking in Commodity IoT”, arXiv preprint arXiv:1802.08307 (2018); all of which are hereby incorporated by reference herein in their entireties. Although several threats to these systems have become apparent, there is no related art comprehensive security solution that addresses these threats and secures the system.

The framework of Chakravorty et al. only focuses on securing shared data in a smart home. Any malicious behavior in a smart environment remains undetected by this framework. One main limitation of the Mohsin et al. framework is that it is not tested against any malicious behavior, which decreases its credibility as a security measure in a smart environment system. It also focuses on detecting denied and incorrect device behavior only, which limits its effectiveness. With respect to Jia et al., the dependency on user permission makes it less suitable for detecting malicious behavior in a smart environment in real-time. The Celik et al. framework is only effective for detecting apps whose source code is available to users, and this framework does not consider the context of the devices and users of the smart environment. Compared to these related art frameworks, embodiments of the subject invention provide a context-aware security framework that uses behavior analysis and usage patterns to detect malicious activities at run time and ensures security against different threats to smart environment systems with high accuracy using machine learning techniques. Embodiments of the subject invention provide at least the following advantages over related art frameworks: can monitor the smart environment system constantly and detect malicious activities in real-time; does not rely on user permissions, so it can detect malicious activities even if a user gives permission to a malicious app; can be a run-time solution that does not need any static analysis of malicious apps; and is easily scalable (e.g., users can add new smart devices in the system, and the framework can detect the devices and start capturing activity contexts and monitor the activities).

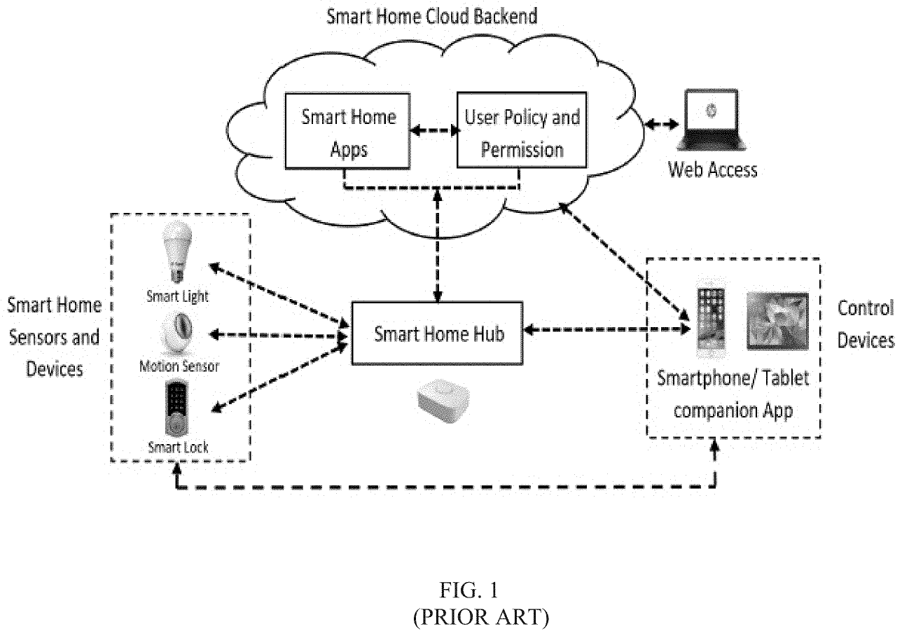

The term smart home is commonly used to portray a residence comprising numerous connected entities (e.g., sensors and devices) that are capable of communicating with each other and can be controlled both centrally (via a hub) and remotely (e.g., via a smartphone). In FIG. 1, a typical architecture of a SHS is shown. Different SHSs, such as Samsung Smart-Things, Apple's Home-Kit, and Google's Weave, use a similar design. The only difference among these platforms is in the communication protocol used to connect the components. A SHS has four basic building blocks as shown in FIG. 1. The first block of SHS includes sensors and devices in the system. These smart home devices and sensors are connected to each other via a smart home hub. As there is no generic interoperability standard among smart home devices, a hub provides a common access point for all the entities in the SHS. The hub is connected to both a cloud backend service and a smartphone/tablet companion app. Users can use the smartphone app to control the smart home entities or install different apps from the app stores. The installed apps run in the cloud backend and provide desired functions to the users. Users may also develop their own apps using the web interface of the cloud backend part of the SHS. For example, Samsung SmartThings allows its users to publish their own apps and share them with other users. Users can develop their own app or simply copy the source code available online to install the app in their SHS. On the other hand, some smart home platforms (e.g., openHAB) only allow users to install certified apps offered by trusted vendors that seem secure, but limits the functions and user control of the SHS. Other platforms, such as Samsung SmartThings, allow users to develop and install apps from their app markets; these platforms perform manual checking to determine whether an app is malicious or not before publishing it publicly, which usually takes several months. Moreover, there are no security measures to detect malicious activities after installing an app in SHS. This lack of security in SHS can lead to several malicious attacks on SHS.

When considering smart environment apps that can be installed in smart environment devices and execute several malicious activities, the threat model can include the following: (1) malware (see e.g., Celik et al. and Jia et al., supra.); (2) ransomware (see e.g., Fernandes et al., Security analysis of emerging smart home applications, In Security and Privacy (SP), 2016 IEEE, which is hereby incorporated by reference herein in its entirety); and (3) vulnerable apps that contain design flaws that can be harnessed by other malicious apps in the SHS (see e.g., Fernandes et al., supra.). To better capture the threat model, it can be classified in the following five categories:

Threat 1—Malicious Behavior 1. An unauthorized smart environment user can steal valid user credentials using a malicious app and try to get access to smart environment devices or applications. This threat represents impersonating a valid user.

Threat 2—Malicious Behavior 2. A malicious smart environment app can exist in the system and inject forged data to perform malicious activities. This threat represents false data injection in a smart environment device.

Threat 3—Malicious Behavior 3. A malicious smart environment app with design imperfections installed in the system can perform legitimate, yet vulnerable, side-channel activities that can be harnessed by other malicious apps in the system or the attacker himself. This threat represents a side channel attack on smart environment devices.

Threat 4—Malicious Behavior 4. A malicious smart environment app installed in the system can impede normal behavior of other smart environment devices and applications. This threat represents denial-of-service attack in a smart environment system.

Threat 5—Malicious Behavior 5. A malicious smart environment app can exist in the system and can be triggered by a specific activity pattern (e.g., switching a smart light in a specific on/off pattern) in a smart environment.

Frameworks of embodiments of the subject invention (which can also be referred to as “HomeGuard”) utilize an anomalous behavior analysis method by building a context-aware model from the normal behavior of smart environment devices, users, and sensors.

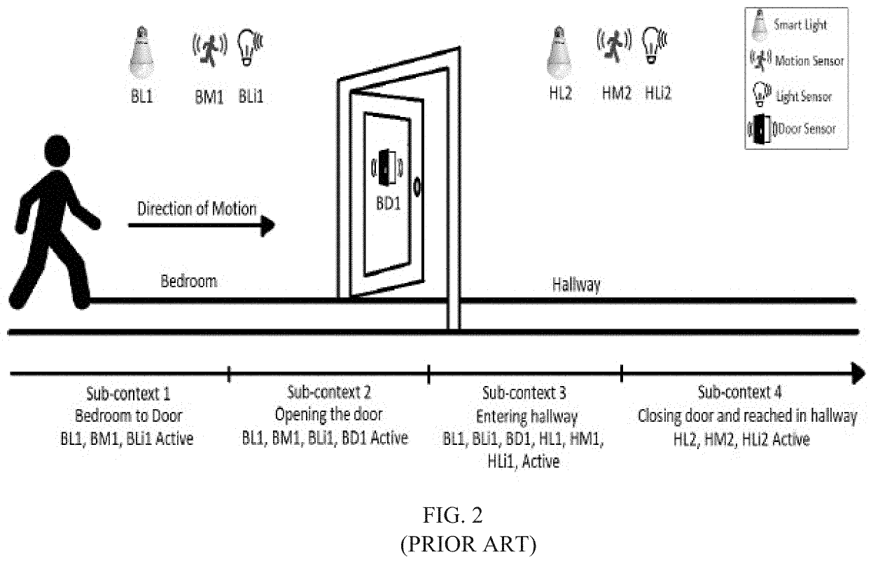

Context-awareness refers to the ability of a system to use situational and environmental information about user, place, and devices to adapt its operation accordingly. Embodiments of the subject invention build a context-aware model by observing the behavior of smart environment sensors and devices in a smart environment system for different user activities and usage patterns. Though the term SHS may be used herein, it can also refer to any smart environment system; similarly, when the term smart home is used herein, it can also refer to any smart environment. In a SHS, sensors are used to provide input in the devices, and devices make autonomous decisions based on these inputs. When a user performs a task in a SHS, several smart home sensors and devices may remain active in a sequential pattern. The pattern of active devices and sensors is different, but specific for different user activities. The framework can observe these patterns in the states of sensors and devices over time and understand the context of user activity. For example, while a user moves from one bedroom to a hallway, several devices and sensors become active in the following sequential manner, as depicted in FIG. 2: moving towards bedroom door (sub-context 1: BL1, BLi1, BM1 are active); bedroom door opens (sub-context 2: BL1, BLi1, BM1, BD1 are active); entering the hallway (sub-context 3: BL1, BLi1, BD1, HLi2, HL2, HM2 are active); and bedroom door and light close and reaches the hallway (sub-context 4: HLi2, HL2, HM2 are active). To complete the activity (moving from bedroom to hallway), a user must follow the sub-contexts in the same sequential pattern. The user cannot skip one sub-context and move to the next one to complete the activity. For instance, transition from sub-context 1 directly to sub-context 4 is not possible as the user cannot go to the hallway from the bedroom without opening the door. The framework considers such sequential usage patterns and differentiates between benign and malicious activities of smart home devices and sensors.

Anomalous behavior analysis refers to a model that defines all the normal behavior in a system to differentiate abnormal behavior. The capability of detecting unknown attacks makes anomalous behavior analysis suitable for smart home security framework. However, the major challenge to implement such an analysis method in a SHS is to establish the ground truth from normal behavior with a low false positive rate. In order to overcome this problem in SHSs, an anomalous behavior analysis of the devices based on user activities and usage patterns can be used. Any device action in a smart home can be associated with user activities. The framework observes day-to-day user activities and automatic changes on devices for these activities as well as any manual changes made by the user. For example, a user can set a security camera to take pictures whenever a motion is detected in the associated sensors. Here, the normal action of the camera is defined in the system. Again, connected devices can also be controlled manually by users via their smartphone/smart tablet apps (e.g., Samsung SmartThings, Apple HomeKit). For example, a user can unlock a door by using the smartphone app. Both automatic and manual operations of the devices can be considered by observing user activities and usage patterns to build the ground truth of the framework.

In a SHS, sensors and devices can be configured as independent entities. However, they work in a co-dependent manner to provide autonomous functionalities in a smart home. For example, smart lights can be configured with motion sensors to light up when motion is sensed in the surroundings. Here, the smart light depends on the input from the motion sensor. The motion sensor alone cannot provide any significant function in a SHS, so the function of a device and a sensor creates a co-dependent relationship with each other. In this way, sensors and devices in the SHS can build a many-to-many co-dependent relationship. For example, a smart light can be configured with both a motion sensor and a door sensor. In this case, the light may light up if either of the motion sensor or the door sensor becomes active. Similarly, a sensor can be configured with multiple devices at a time. For each user activity in the SHS, several entities remain active in a definite pattern. The framework considers this co-dependent relationship and builds the context of a user activity by observing the usage pattern of smart home entities. In short, sensors and devices in a SHS are configured as independent components, but function in a co-dependent manner, and the framework considers this relation to build the context of user activities.

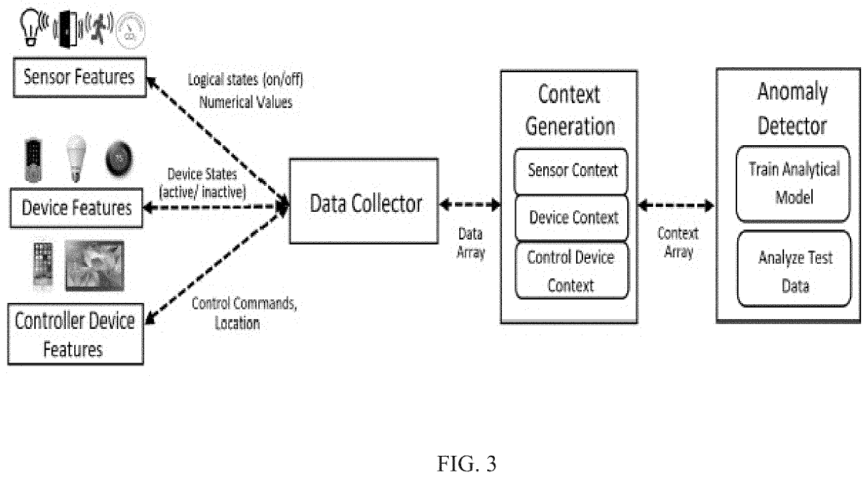

A security framework for detecting malicious activities in a smart environment system, according to embodiments of the subject invention, can include the following modules: (1) data collector; (2) context generator (or context generation); and (3) anomaly detector module (data analysis) (see FIG. 3). The data collector module collects data from smart environment entities (sensors and devices) for day-to-day user activities, and the dataset of this data is fed into the context generator module to create context arrays depending on the usage pattern and predetermined user policies. The context arrays generated in the context generator module are fed into the anomaly detector module (i.e., data analysis module), which decides whether or not any malicious activity is running in the smart environment system. Below is more detail on each module.

Data Collector Module—The framework collects data from smart environment devices and sensors using the data collector module. In a smart environment system, there can be multiple devices and sensors connected through a hub and operating in a co-dependent manner. The data collector collects the state of these devices (active or inactive) autonomously and forwards these data to the context generation module. Based on the type of data, the collected data is governed by:

Data array,E={S,D,M}, (1)

where E is the data array, S is the set of features extracted from the sensors, D is the set of features extracted from the devices, and M is the set of features extracted from the associated controller devices (e.g., smartphone, smart tablet) in a smart environment system.

Features extracted from sensors (S): An SHS can include several sensors such as motion sensors, light sensors, door sensors, smoke sensors, etc. These sensors sense changes in the vicinity of the devices and work as input to multiple devices. Sensor data can be both logical states (e.g., motion sensor) and numerical values (light sensor). Both logical states and numerical values of sensors can be considered to create the context of user activities.

Features extracted from devices (D): In a SHS, several devices can be connected with each other and also with different sensors. These devices can remain active based on user activities in a smart environment. The framework observes daily activities of users and collects the device state data (active/inactive state) to build the context of the associated activity.

Features extracted from controller devices (M): In a SHS, a smartphone or tablet can work as a control device to the SHS, and users can control any device using the associated smart app of the smart home. The framework can consider any control command given from the controller device as a feature to understand the context of a user activity. Additionally, the location of the connected controller device can also work as an input to control multiple devices. For example, a thermostat can be configured to a desired temperature whenever the smartphone of the user is connected to the smart home network. The framework can consider the location of the controller device as a feature to build the context of user activities.

As user activities on a SHS can vary based on the number of users, the framework can consider multi-user settings to understand the user activity contexts correctly. Moreover, user activities also change based on the daily routine of users. For this in the data collection process, the framework can also offer time-based activity settings (weekday and weekend settings).

Context Generation Module—the data collector module forwards the collected data to the context generation module to build the contexts of different user activities in a SHS. Based on the features of collected data, the context generation module maps the data and aggregates them to build context arrays. Each context array includes information of the usage patterns in the SHS for different activities, which can be used for further analysis and determine malicious activities in the system. The context array modeling process can have the following steps.

Context of sensors: Sensor features collected in the data collector include both logic state (on/off) and numerical values. The framework can observe the sensor data and generate the conditions of the sensors. Here, the conditions of the sensor can represent the changing pattern of the sensor. If the sensor value (logical and numerical) changes from the previous value, the framework can consider this as an active condition and represent as 1, and 0 otherwise.

Context of devices: Data collector of the framework collects device state (active/inactive) data for every connected device in a SHS. These device state data are converted to logical state (1 represents active and 0 represents inactive) to build the context of user activities on a SHS.

Context of controller devices: There are two features of the controller device (e.g., smartphone, tablet, etc.) that are collected by the framework: control command for smart home devices; and location of the controller device. For any command from the smartphone/tablet, the framework considers active condition of smartphone/tablet, which is represented as a 1 in the context array and a 0 otherwise. An SHS allows two different states to represent the location of the controller device—home and away. Home location indicates that the controller device is connected to the home network, and away indicates that the controller device is disconnected from the smart home. The framework represents home location of the smartphone as 1 and away location as 0 in the context array. The final context array can be represented as follows:

Context Array,C=[{S₁,S₂, . . . S_{X}},{D₁,D₂, . . . ,D_{Y}},{M₁,M₂}] (2)

where S₁, S₂, . . . , S_{X} captures the conditions of X number of sensors in the SHS, D₁, D₂, . . . , D_{Y} the conditions of Y number of sensors in the SHS, and M₁, M₂ the conditions of smartphone/tablet in the SHS.

Anomaly Detector Module—The framework can take context arrays generated in the context generation module as input and train a machine learning model (e.g., a Markov Chain-based machine-learning model), which is used to detect malicious activities in the smart environment. A Markov Chain model can be described as a discrete-time stochastic process that takes an array of defined variables and builds a prediction model by observing the changes of variables over time. The Markov Chain model is based on two main assumptions: (1) probability of occurring a state at time t+1 only depends on the state at time t only, where the state represents overall condition of the stochastic process; and (2) transition between two consecutive states is independent of time. The framework uses this Markov Chain model to illustrate a series of events in a SHS. Here, a series of events denotes user activity and usage pattern, and the state represents the context array at a specific time generated in the context generation module. The probabilistic condition of Markov Chain model is shown in Equation 3, where Xₜ denotes the state at time t for a user activity in the SHS.

P(Xₜ₊₁=x|X₁=x₁,X₂=x₂ . . . Xₜ=xₜ)=P(Xₜ₊₁=x|Xₜ=xₜ), when, P(X₁=x₁,X₂=x₂ . . . ,Xₜ=xₜ)>0 (3)

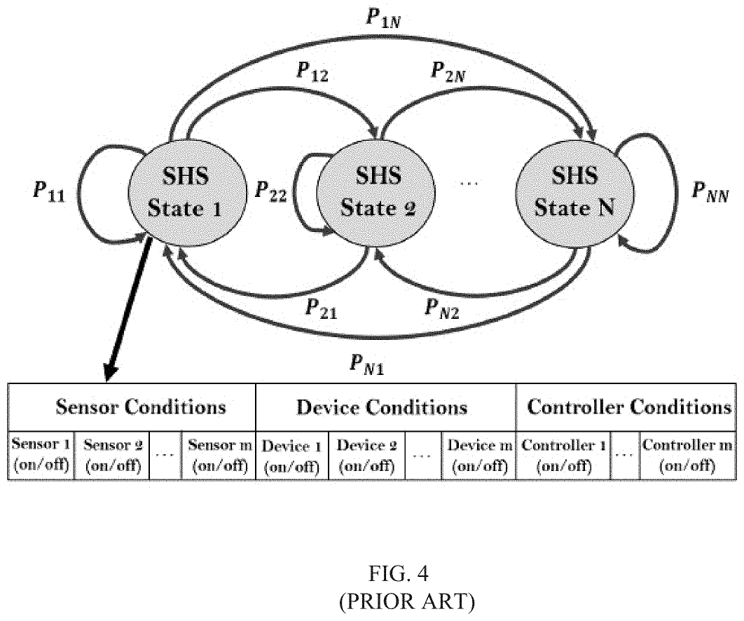

The framework considers the context array given in Equation 2 as an array of variables and observes the changes over time. For every user activity on a SHS, several context arrays are created and these arrays follow a different, but specific, pattern for different user activities. Each element of the context array represents the condition of a smart home entity (active/inactive status of sensor, device, or smartphone). For a distinct time, t, the combination of all the smart home devices' and sensors' condition can be considered as binary output (1 for active status of an entity and 0 for inactive status). Thus, the number of total state (A) will be exponent of 2 and can be represented as a n-bit binary number, where n is the total number of entities in the SHS. Assume Pᵢⱼ denotes the transition probability of the system from state i at time t to state j at time t+1. If the SHS has n number of entities and m=2n states in the system, the transition matrix of Markov Chain model can be illustrated by FIG. 4. Here, each transition probability from one state to another state represents an element of transition matrix.

If the SHS has X₀, X₁, . . . , X_{T} states at a given time t=0, 1, . . . , T, respectively, the elements of the transition matrix can be shown as

$$Pij = \frac{{N}_{ij}}{{N}_{i}}$$

where N denotes the number of transition from Xₜ to Xₜ+1, where Xₜ is the state at time t, and Xₜ+1 is the state at time t+1. Instead of predicting the next state using this Markov Chain model, the framework can determine the probability of transition between two states in the SHS at a given time. The Markov Chain model can be trained with the generated context arrays from the context generation module and construct the transition matrix. Using this transition matrix, the framework can determine the probability of transition from one state (i.e., context array) to another state over time. For example, in FIG. 2, a walking context is presented from a bedroom to a hallway. This activity creates four sub-context arrays in the context generation module: sub-context 1=bedroom motion sensor and light are active (BL1, BLi1, BM1), sub-context 2=bedroom door open (BL2, BLi2, BM2, BD2), sub-context 3=hallway motion sensor and light active (BL1, BLi1, BD1, HLi2, HL2, HM2), and sub-context 4=bedroom door and light close (HLi2, HL2, HM2). The transition between sub-context 1 and sub-context 2 is valid as the user can perform this activity. However, a transition from sub-context 1 directly to sub-context 4 is invalid as the user cannot go from the bedroom to the hallway without opening the door and performing sub-contexts 2 and 3. Thus, the framework defines benign device behavior based on user activities.

Embodiments of the subject invention have advantageous applications in at least the field of security, including malicious app detection, secured information flow between devices, device security posture, and identification of malware triggering via sensors. Embodiments can work with existing smart environment systems (e.g., Samsung SmartThings, Apple Homekit, OpenHAB, etc.), such that the security of smart systems and devices can be enhanced. This technology will improve security of smart devices with sensors against malicious attacks. Embodiments can also be used in the Internet of Things (IoT) domain to improve security of any IoT devices with sensors; this can help to provide privacy for users and secure information flow from sensors to application layer in IoT devices. Embodiments can also be used to enhance the security and privacy of smart devices by providing a cloud-based and device-based implementation that observes the operating state (on/off) of the devices and builds a contextual model to detect different threats in these devices.

With respect to malicious app detection, modern smart systems enable users to download and install third party apps in the devices. Because users usually do not verify whether an app is form a trusted source, attackers can easily abuse smart devices by changing the source code of an app. Embodiments can monitor the states of devices (on/off or active/active) in real-time and build a contextual model to identify any malicious activities in a smart environment system.

With respect to secured information flow between devices, smart systems include multiple devices that use personal information to perform a task. Devices in a smart system exchange this information with each other, which increases the probability of information leakage. Embodiments constantly monitor the states of devices to understand activities of the devices, thereby ensuring secure information flow between devices.

With respect to device security posture, embodiments can give overall security status of a smart system. The framework can observe each connected device in the smart system and identify any on-going malicious activities in real-time.

With respect to identifying malware triggering via sensors, different attack scenarios have shown malware planted on a device can be triggered using another device. Embodiments can also detect this type of malicious attack.

Embodiments of the subject invention ensure secure information flow between different smart devices (e.g., smart lights, smart cameras, smart locks, etc.), which are connected with each other and share information. This information can be leaked via sensors, communication channels, etc., which could lead to different criminal activities like impersonation, breaking into a house, robbery, etc. The framework can detect malicious information sharing to help prevent or inhibit these threats. Embodiments also enhance usability of smart devices. Current smart environment systems do not allow users to learn about how different apps are controlling different devices. As smart devices are connected with each other, it would be beneficial for users to know which devices are interconnected and sharing information with each other. Embodiments can create a contextual model using the operation states of the connected devices to provide a detailed overview of the device functionalities. Users can monitor the operation of each device and check whether a device is working properly or not. The framework can also alert users about any malfunctioning device.

The intrusion detection technology of embodiments of the subject invention is simple to implement and works against different attacks in smart environment systems with high accuracy. The overhead of the technology is minimal, and it can be implemented easily on existing smart environment platforms. As more devices are integrated into smart systems that deal with sensitive user information, the possibility of different attacks in smart environments is also increasing. With increasing investment in device industries and growing security concerns for smart devices, IoT devices, and industrial IoT devices, embodiments of the subject invention have many useful applications.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to the invention.

### Materials and Methods

The effectiveness of the security frameworks of embodiments of the subject invention in detecting malicious activities in a SHS was tested with real user data. The anomaly detector module of the framework was trained with data collected from multiple smart home users for benign daily activities. For testing purposes, the user data and the malicious data collected from the adversary model described herein were used.

To test the efficacy of the framework, daily usage data of a SHS was collected from multiple smart home users. An emulation-based environment where users can emulate their daily activities in a time order was used. While collecting the user activity data, the following features were considered to enrich the dataset and perform a detailed evaluation of the framework.
Anonymous User ID: For each user, an anonymous ID was assigned to ensure the privacy of the user in the dataset.
User Role: In a SHS, user activities vary with their role in the home. For example, a working adult may be spending less time than a person working from home; hence, he/she may perform less interaction in the SHS. The user role was considered to understand the context of the user activities in a multi-user scenario in the SHS.
Smart Home Layout: User activities can vary based on the layout of the home and number of smart devices available in the SHS. Three different smart home layouts (single bedroom apartment, two bedroom home, and duplex home) were considered, and users were allowed choose their preferred layout. Additionally, users were also allowed to add their preferred smart devices in the SHS.
Activity Day-time: User activity in a SHS depends on the user's daily routine, which may change for different days of the week. For example, a working adult may spend more time at home on the weekends than weekdays, which increases user interaction in SHS. This was considered while collecting data, and two different datasets were captured from each user to emulate the weekday and weekend activities. The time of the activity was also considered while collecting the data.
User Policy: the current smart home platforms let users define multiple policies and control smart home devices. The context of user activities may change based on user-defined policies in SHS. For example, a smart light can be controlled via the motion sensor, door sensor, or presence sensor. To understand the event associated with the light sensor and build the context of user activity, one must understand the user-defined policy enforced in the smart light. This property of the SHS was addressed by allowing users to define their own policies in the SHS in the data collection process.

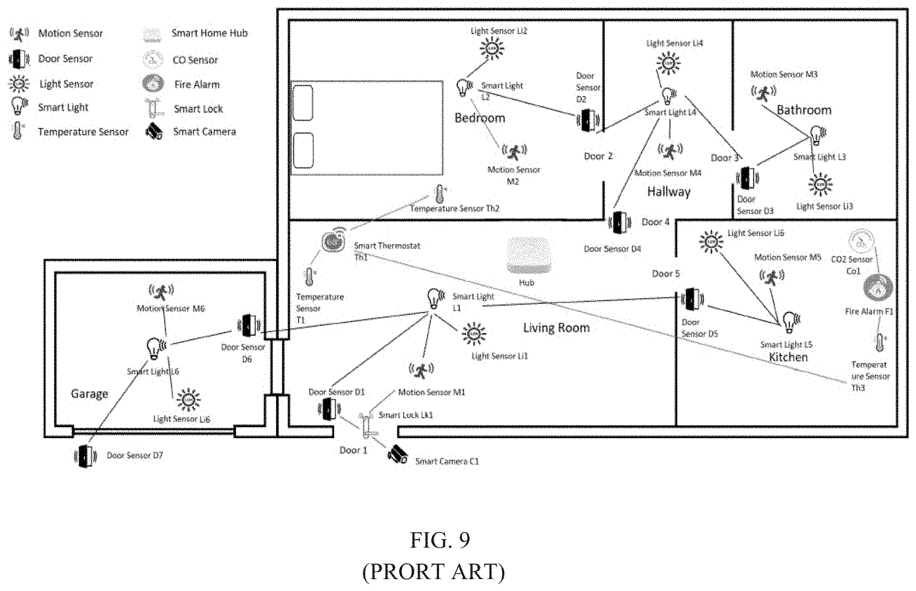

Moreover, the users emulated their daily activities in a smart home setting, and the user activity data was collected using the data collection module of the framework in a real-life smart home setting. In the emulation environment, users illustrated their day-to-day activities in a smart home layout. FIG. 9 shows the layout of the emulator where users replicated their daily activities in a smart home layout. In particular, FIG. 9 shows the single bedroom layout; the double bedroom and duplex home layouts used similar emulators. Users imitated their daily activities simply clicking in different devices in the emulator. These listed daily activities were also performed in a real-life setting to collect real data from the SHS. The Samsung SmartThings platform was used to create the smart environment because of its large app market and compatibility with other smart devices. The most common devices were used for the smart environment. A detailed list of devices that were used in the experiments is given in Table 1 below. Data from 15 different individuals with different user roles, user policies, and smart home layouts was collected. The total dataset included over 45,000 events collected in a 7-day period. Samsung SmartThings allows devices to list events and store the log files for 7 days. An app was created and used the ListEvent command to collect the device log, which included all the events triggered by users, and these were sent to the context acquisition module.

TABLE 1
List of smart devices used

| Device Type | Model | Description |
|---|---|---|
| Smart Home Hub | Samsung SamrtThings | Works as a central access point for |
| | Hub | smart house entities. |
| | | Supports Wi-Fi, ZigBee, and Z-Wave. |
| Smart Light | Philips Hue Light Bulb | Uses a separate communication |
| | | bridge to connect with smart home hub. |
| | | Uses ZigBee to communicate with |
| | | other components in SHS. |
| | | Supports up to 12 different sensors. |
| Smart Lock | Yale B1L Lock with | Uses Z-Wave to connect with other |
| | Z-Wave Push Button | devices. |
| | Deadbolt | Offers different pin code for different |
| | | users. |
| | | Provides both manual and remote |
| | | access. |
| Fire Alarm | First Alert 2-in-1 | Uses Z-Wave to connect with the hub |
| | Z-Wave Smoke Detector | Provides built-in smoke and CO |
| | and Carbon Monoxide | sensors. |
| | Alarm | |
| Smart Monitoring | Arlo by NETGEAR | Uses Wi-Fi to connect with smart |
| System | Security System | home hub. |
| | | Offers both live monitoring and still |
| | | pictures. |
| Smart Thermostat | Ecobee 4 Smart | Uses Wi-Fi to connect with smart hub. |
| | Thermostat | Can be configured with sensors. |
| Smart TV | Samsung 6 Series | Connects with smart home hub using |
| | UN49MU6290F LED | Wi-Fi. |
| | Smart TV | |
| Motion Sensor | Fibaro FGMS-001 | Uses Z-Wave to connect with the hub. |
| Light Sensor | Motion Sensor | Can be configured with different |
| Temperature Sensor | | devices simultaneously. |
| Door Sensor | Samsung Multipurpose | Uses ZigBee protocol to connect with |
| | Sensor | smart home hub. |

In order to collect the malicious dataset, five different attack scenarios and their associated smart home apps were created based on the adversary model discussed herein. To perform the attack described in Threat 1, a battery monitor app for smart locks that leaks the unlock code via SMS to the attacker was created. The impersonation attack was realized by unlocking the smart lock as an outsider using the leaked unlock code. For Threat 2, an app was built that injects false smoke sensor data to trigger the fire alarm in the SHS. For Threat 3, an app was created that flickered a smart light in a specific pattern while nobody was in the home. To perform the denial-of-service attack described in Threat 4, an app was developed that stopped the smart thermostat for a pre-defined value. For Threat 5, an app was developed that could generate Morse code using a smart light while no person was in the room and triggered a smart camera to take stealthy pictures. In total, five new apps were created to be used for different threats. The five threat models are summarized in Table 2 below.

TABLE 2
Malicious app mapping

| Threat Model | ContextIoT [16] | IoTBench [39] |
|---|---|---|
| Threat-1 | Backdoor pin code injection. | Permissions- Implicit 2 |
| | Lock access revocation. | |
| | LockManager. | |
| | App Update - PowersOutAlert. | |
| Threat-2 | Fake alarm. | — |
| | Remote contril - FireAlarm. | |
| | Remote command - | |
| | SmokeDetector. | |
| Threat-3 | Leaking information. | Side Channel - Side |
| | creating seizures using | Channel 1. |
| | strobed light. | Side Channel - Side |
| | IPC - MaliciousCameraIPC & | Channel 1. |
| | PresenceSensor. | |
| | MidnightCamera. | |
| Threat-4 | Disabling vacaction mode. | — |
| | Abusing permission. | |
| Threat-5 | Surreptitious surveillance. | — |
| | Undesired unlocking. | |
| | IPC - MaliciousCameraIPC & | |
| | PresenceSensor. | |

Additionally, some malfunctioning devices (e.g., smart lock without power, fused smart light, etc.) were added in the SHS to test the framework against device malfunction. Twenty-four different datasets were collected and included 10,000 events from these attack scenarios to test the efficiency of the framework. 75% of the normal user data was used to train the Markov Chain model of the framework, and 25% of the data of the malicious dataset was used in the testing phase. To evaluate the framework, six different performance metrics were utilized: true positive rate (TPR), false negative rate (FNR), true negative rate (TNR), false positive rate (FPR), accuracy, and F-score. TPR indicates the percentage of correctly identified benign activities; TNR refers to the percentage of correctly identified malicious activities; FPR indicates the number of malicious activities identified as benign; FNR indicates the number of benign activities detected as malicious activities; and F-score is an indicator of accuracy of a framework that considers TPR and TNR as computational vector. The performance metrics are defined by the following equations:

$$\begin{matrix}TP rate = \frac{TP}{TP + FN} , & ( 4 ) \\ FN rate = \frac{FN}{TP + FN} , & ( 5 ) \\ TN rate = \frac{TN}{TN + FP} , & ( 6 ) \\ FP rate = \frac{FP}{TN + FP} , & ( 7 ) \\ Accuracy = \frac{TP + TN}{TP + TN + FP + FN} , & ( 8 ) \\ F \text{-} score = \frac{2 * TP * TN}{TP + TN} . & ( 9 )\end{matrix}$$

### Example 1—Evaluation with Different Home Layouts

User activities in a smart home setup can vary depending on the smart home layout as different layouts of smart home can lead to different usage patterns. In evaluating the framework, three different layouts were considered: single bedroom home; double bedroom home; and duplex home. A single authorized smart home user was considered in different layouts. Data was collected from 15 different users in these layouts. Table 3 presents the evaluation results associated with different smart home layouts. It can be observed that accuracy and F-score for different layouts varies from 96-91% and 97-95%, respectively. The framework also achieved high TPR (96-91%) and TNR (100%) irrespective of layouts. Variation in different layouts had very limited impact on the performance of the framework.

TABLE 3
Performance evaluation for different smart home layouts

| Smart Home | | | | | | |
|---|---|---|---|---|---|---|
| Layout | TPR | FNR | TNR | FPR | Accuracy | F-score |
| Single Bedroom Home | 0.96 | 0.04 | 1 | 0 | 0.9604 | 0.9796 |
| Double Bedroom Home | 0.93 | 0.07 | 1 | 0 | 0.9340 | 0.9655 |
| Duplex Home | 0.91 | 0.09 | 1 | 0 | 0.9119 | 0.9529 |

### Example 2—Evaluation in a Multi-User Environment

Smart home platforms allow users to add more than one authorized user for the same SHS. Hence, a SHS can have multi-user scenarios with different user activities happening at the same time. In order to evaluate this setting of the smart home in the framework, data was collected from several multi-user settings with different users emulating their daily activities at once. Different smart home layouts were used with several multi-user scenarios (two authorized controllers/conflicting users, three authorized controllers/conflicting users, and four authorized controllers/conflicting users) in the data collection process. The attack scenarios were performed to collect a malicious dataset and test the efficiency of the framework in different multi-user environments. Table 4 illustrates the detailed evaluation of the framework in different smart home settings.

For a single bedroom layout of the SHS, the accuracy and F-score reached the peak (0.9477 and 0.9729, respectively) for the two-user setup. If the number of authorized users in the SHS is increased, the accuracy gradually decreases with an increasing FNR. Similarly, for the two bedroom and duplex home layouts, the framework achieved the highest possible accuracy and F-score for the setup with two authorized users. Both accuracy and F-score decreased while FNR increased as the number of authorized users increased. The highest accuracy achieved in two bedrooms and duplex home layouts are 92.29% and 90.38%, respectively. Because different users interact with smart home devices in varied ways, the FNR increases with the number of users in the system. In summary, the framework achieved over 90% of accuracy for different multi-user settings of the tested smart home layout.

TABLE 4
Performance evaluation for different multi-user scenarios

| Smart Home | No of | | | | | | |
|---|---|---|---|---|---|---|---|
| Layout | Controllers | TP | FN | TN | FP | Accuracy | F-score |
| Single Bedroom | 2 | 0.9472 | 0.0528 | 1 | 0 | 0.9477 | 0.9729 |
| Home | 3 | 0.9399 | 0.0601 | 1 | 0 | 0.9405 | 0.9690 |
| | 4 | 0.9041 | 0.0959 | 0.96 | 0.04 | 0.9352 | 0.9312 |
| Double Bedroom | 2 | 0.9222 | 0.0778 | 1 | 0 | 0.9229 | 0.9595 |
| Home | 3 | 0.9058 | 0.0942 | 0.9529 | 0.0471 | 0.9062 | 0.9288 |
| | 4 | 0.8806 | 0.1194 | 0.8941 | 0.1059 | 0.8807 | 0.8873 |
| Duplex Home | 2 | 0.9017 | 0.0983 | 1 | 0 | 0.9038 | 0.9483 |
| | 3 | 0.8901 | 0.1099 | 0.9238 | 0.0762 | 0.8909 | 0.9067 |
| | 4 | 0.8694 | 0.1306 | 0.8857 | 0.1143 | 0.8698 | 0.8775 |

### Example 3—Evaluation Based on Sensor Input

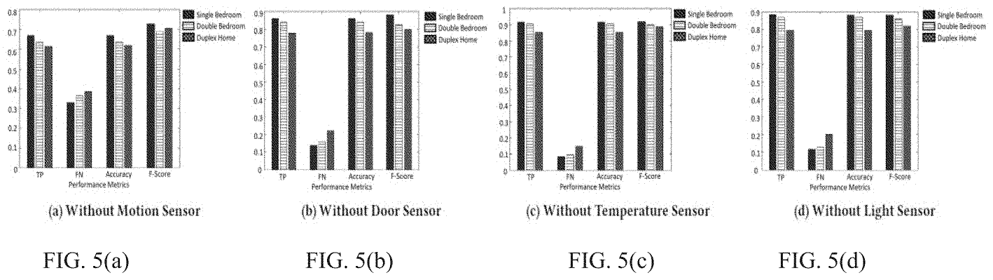

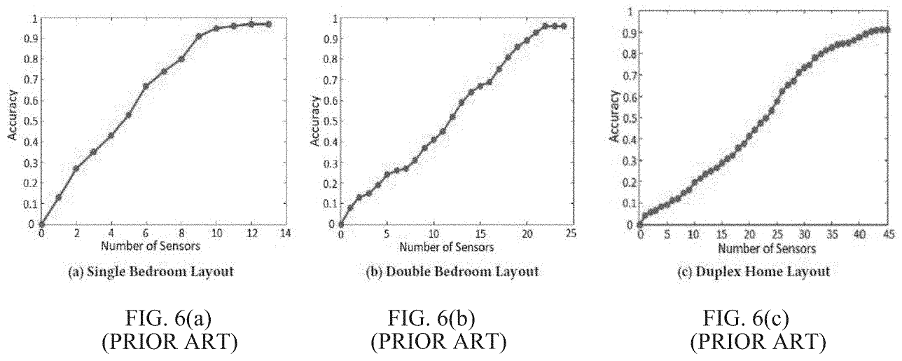

In order to evaluate the efficiency of the framework based on deployed sensors, several combinations of sensors were used to build the context-aware model of user activities and report performance metrics in FIG. 5. Because the framework considers different smart home sensors and devices as co-dependent components in its context-aware model, it is useful to understand to what extent changing the combinations of sensors in a SHS affects the framework's performance. The efficacy of the framework was tested with four different combinations of sensors: without a motion sensor (FIG. 5(a)), without a door sensor (FIG. 5(b)), without a temperature sensor (FIG. 5(c)), and without a light sensor (FIG. 5(c)). Referring to FIGS. 5(a)-5(d), decreasing the number of sensors from the context-aware model in the framework declines the accuracy and F-score of the framework. Removing the motion sensor resulted in the lowest accuracy and F-score (61% and 68% in duplex home layout, respectively). As motion sensors are configured with the majority of the devices (smart light, smart lock, etc.) and used in the most of the user activity context, it affects the performance of the framework significantly. It can also be observed that removing sensors from the SHS introduces a high FNR as the framework cannot build the context of the user activities correctly. FIG. 5(c) shows that removing the temperature sensor from the SHS does not influence the performance significantly (85-91% accuracy and 88-91% F-score in different layouts). The main reason is that the temperature sensor can be configured with a limited number of devices; hence, it is less affected by user activities than other sensors are. Without the door sensor and light sensor, the framework can achieve moderate accuracy ranges from 77%-86% and 79%-88%, respectively. FIGS. 6(a)-6(c) show the change in accuracy of the framework for changing the number of sensors in different smart home layouts. For all three smart home layouts (single bedroom, double bedroom, and duplex home), limiting the number of sensors in the system decreases the accuracy of the framework. It can be seen that limiting the number of sensors in a SHS can reduce the efficiency of the framework by introducing false negative (FN) cases in the system.

### Example 4—Evaluation Based on User Policies

Modern smart home platforms offer policy-based functionalities where users can define customized policies to control the smart home devices. For example, users can impose a time window to activate a smart light in a SHS. The efficiency of the framework was tested with different policies enforced in SHS. The following user policies were considered:
User Policy 1: Users can apply time-specific operations for different smart home entities. In Policy 1, users configure time-specific operations for smart light in the SHS. For example, users can configure a smart light with motion sensor which will be enforced only from sunset to sunrise.
User Policy 2: Users can apply sensor specific operations for different smart home devices. For example, users can configure a smart light to activate with both motion sensor and door sensor. In Policy 2, users configure smart lights with the light, motion, and door sensors.

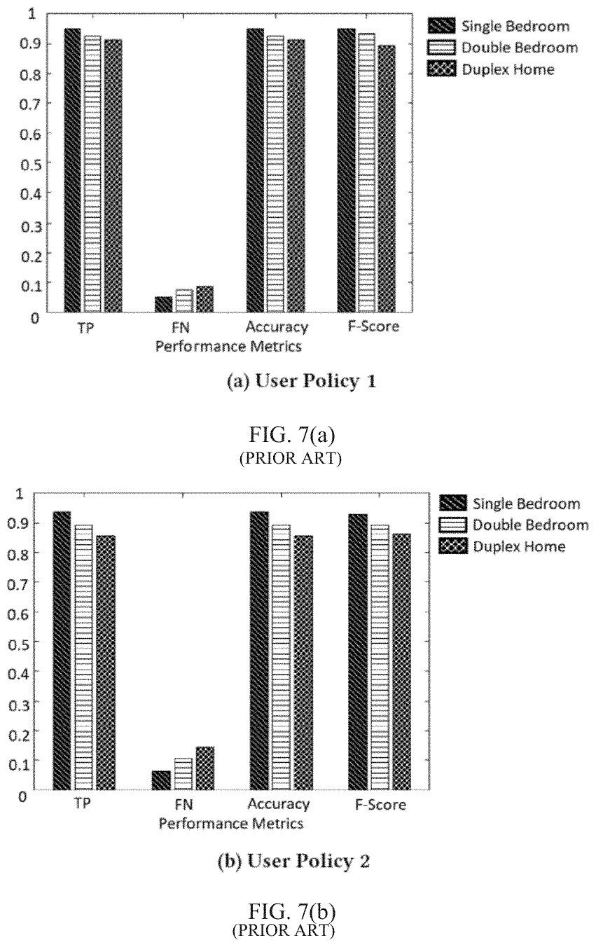

FIGS. 7(a) and 7(b) present the performance of the framework in these policies enforced in SHSs. The framework can acquire accuracy as high as 95% while enforcing time-specific operations in SHS (FIG. 7(a)). The F-score also ranges from 89% to 94% for different smart home layouts with time-specific operations with low FNR (5%-8%). For User Policy 2, a slight fall in the accuracy and F-score occurs as changing sensor-device configuration introduces FN cases in the system. Referring to FIG. 7(a), the framework can perform with an accuracy ranging from 85% to 93% for different smart home layouts while changing the sensor-device configurations. The framework also achieved F-score ranging from 86.5-92% for different configurations. Overall, the framework can detect malicious activities in policy-enforced SHS with high accuracy and F-score.

### Example 5—Evaluation Based on Installed Apps

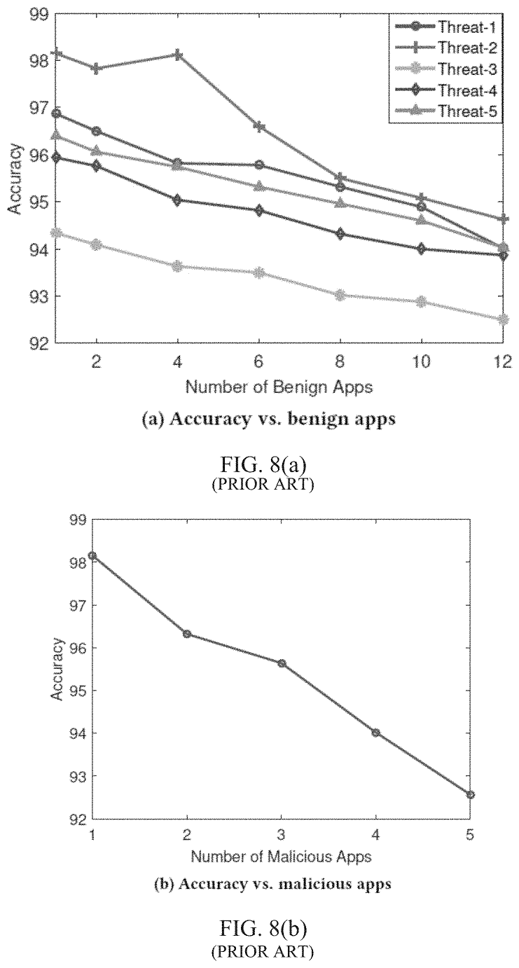

Modern SHS offers multiple smart apps to be installed and run at the same time. These apps can configure and control the same devices or different devices. For example, users can install an app to control a smart light with a motion sensor and another app to control a smart light with a door sensor at the same time. In order to test the effectiveness of the framework based on installed apps, 12 benign apps in total were installed in the system to build the context-aware model of user activities. FIG. 8(a) shows the accuracy and F-score of the framework in detecting malicious apps in a SHS based on installed apps. Different types of malicious apps (see also Table 2) were installed in the system with multiple benign apps to evaluate the effectiveness of the framework. Referring to FIG. 8(a), the framework achieved the highest accuracy of 98.15% for Threat-2 and the lowest accuracy of 94.34% for Threat-3 for only one benign smart app installed in the system. With the increment of benign apps in the SHS (highest 12 benign apps), accuracy ranges between 98% to 95% and 94% to 92.5% for Threat-2 and Threat-3, respectively. The accuracy of the framework in detecting Threat-1, Threat-2, and Threat-5 varied between 96% and 93%.

Different malicious apps installed at once in the SHS were tested with a fixed number of benign apps (12 benign apps) to further evaluate the effectiveness of the framework. FIG. 8(b) depicts the accuracy of the framework based on the number of malicious apps installed in the system. The framework achieved an accuracy of 98% for one malicious app installed in the SHS. With the increments of number of malicious apps, the performance of the framework deteriorated very little. Even with five malicious apps installed in the SHS, the framework achieved an accuracy of 92.57%. Overall, the performance changed very little as the number of benign apps or malicious apps installed in the SHS changed.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

1. A system for monitoring activity within a smart environment, the system comprising:
a processor; and
a machine-readable medium in operable communication with the processor and with devices, sensors, and at least one controller of the smart environment, the machine-readable medium having instructions stored thereon that, when executed by the processor, perform the following steps:
collecting, from the devices and the sensors and the at least one controller of the smart environment, data comprising states of the devices and the sensors, the collecting of the data being performed while taking into consideration respective times of activities performed by users of the smart environment;
building context arrays of the activities of the users of the smart environment based on the data collected from the devices and the sensors and the at least one controller, the context arrays comprising a device context array for the devices, a sensor context array for the sensors, and a controller context array for the at least one controller;
training a machine learning model, using the device context array, the sensor context array, and the controller context array to establish benign behavior, to provide a trained machine learning model, the training of the machine learning model excluding use of any context beyond the device context array, the sensor context array, and the controller context array; and
monitoring the smart environment, using the trained machine learning model, to detect malicious activity within the smart environment.

2. (canceled)

3. The system according to claim 1, the machine learning model being a Markov Chain model.

4. The system according to claim 1, the monitoring of the smart environment comprising comparing detected behavior to the established benign behavior and designating the detected behavior as malicious if it is distinct from the established benign behavior.

5. The system according to claim 1, the collecting of the data occurring over a predetermined period of time during which the smart environment is being used by the users.

6. The system according to claim 1, the smart environment being a smart home, smart office, or smart building.

7. The system according to claim 1, the data comprising device features extracted from the devices, sensor features extracted from the sensors, and controller features extracted from the at least one controller of the smart environment, and
the building of the context arrays comprising using exclusively the device features to build the device context array, using exclusively the sensor features to build the sensor context array, and using exclusively the controller features to build the controller context array.

8. The system according to claim 7, the device features comprising logical states of the devices,
the sensor features comprising logical states and numerical values of the sensors, and
the controller features comprising control commands of the at least one controller.

9. The system according to claim 8, the controller features further comprising a location of the at least one controller.

10. The system according to claim 7, the at least one controller comprising a smartphone, a tablet, or both.

11. A method for monitoring activity within a smart environment, the method comprising:
collecting, by a processor in operable communication with devices, sensors, and at least one controller of the smart environment, data from the devices and the sensors and the at least one controller of the smart environment, the data comprising states of the devices and the sensors, the collecting of the data being performed while taking into consideration respective times of activities performed by users of the smart environment;
building, by the processor, context arrays of the activities of the users of the smart environment based on the data collected from the devices and the sensors and the at least one controller, the context arrays comprising a device context array for the devices and a sensor context array for the sensors, and a controller context array for the at least one controller;
training, by the processor, a machine learning model, using the device context array, the sensor context array, and the controller context array to establish benign behavior, to provide a trained machine learning model, the training of the machine learning model excluding use of any context beyond the device context array, and the controller context array; and
monitoring, by the processor, the smart environment using the trained machine learning model to detect malicious activity within the smart environment.

12. (canceled)

13. The method according to claim 11, the machine learning model being a Markov Chain model.

14. The method according to claim 11, the monitoring of the smart environment comprising comparing detected behavior to the established benign behavior and designating the detected behavior as malicious if it is distinct from the established benign behavior.

15. The method according to claim 11, the collecting of the data occurring over a predetermined period of time during which the smart environment is being used by the users.

16. The method according to claim 11, the smart environment being a smart home, smart office, or smart building.

17. The method according to claim 11, the data comprising device features extracted from the devices, sensor features extracted from the sensors, and controller features extracted from the at least one controller of the smart environment, and
the building of the context arrays comprising using exclusively the device features to build the device context array, using exclusively the sensor features to build the sensor context array, and using exclusively the controller features to build the controller context array.

18. The method according to claim 17, the device features comprising logical states of the devices,
the sensor features comprising logical states and numerical values of the sensors, and
the controller features comprising control commands of the at least one controller.

19. The method according to claim 18, the controller features further comprising a location of the at least one controller, and
the at least one controller comprising a smartphone, a tablet, or both.

20. A system for monitoring activity within a smart environment, the system comprising:
a processor; and
a machine-readable medium in operable communication with the processor and with devices, sensors, and at least one controller of the smart environment, the machine-readable medium having instructions stored thereon that, when executed by the processor, perform the following steps:
collecting, from the devices and the sensors and the at least one controller of the smart environment, data comprising states of the devices and the sensors, the collecting of the data being performed while taking into consideration respective times of activities performed by users of the smart environment;
building context arrays of the activities of the users of the smart environment based on the data collected from the devices and the sensors and the at least one controller, the context arrays comprising a device context array for the devices, a sensor context array for the sensors, and a controller context array for the at least one controller;
training a machine learning model, using the device context array, the sensor context array, and the controller context array to establish benign behavior, to provide a trained machine learning model, the training of the machine learning model excluding use of any context beyond the device context array, the sensor context array, and the controller context array; and
monitoring the smart environment, using the trained machine learning model, to detect malicious activity within the smart environment,
the machine learning model being a Markov Chain model,
the monitoring of the smart environment comprising comparing detected behavior to the established benign behavior and designating the detected behavior as malicious if it is distinct from the established benign behavior,
the collecting of the data occurring over a predetermined period of time during which the smart environment is being used by the users,
the smart environment being a smart home, smart office, or smart building,
the data comprising device features extracted from the devices, sensor features extracted from the sensors, and controller features extracted from the at least one controller,
the building of the context arrays comprising using exclusively the device features to build the device context array, using exclusively the sensor features to build the sensor context array, and using exclusively the controller features to build the controller context array,
the device features comprising logical states of the devices,
the sensor features comprising logical states and numerical values of the sensors,
the controller features comprising control commands of the at least one controller and a location of the at least one controller, and
the at least one controller comprising a smartphone, a tablet, or both.
